(19) United States
(12) Patent Application Publication
(10) Pub. No.: US 2006/0232055 A1
(43) Pub. Date: Oct. 19, 2006

(54) Energy absorbing structure

(75) Inventors: Douglas Michael Cappabianca, Canton, MI (US); Joseph Anthony Camilletti III, Sterling Heights, MI (US); Zhenjian Huang, Canton, MI (US); Kumar Balakrishna Kulkarni, Ann Arbor, MI (US); Mark Michael Sheldon, Shelby Township, MI (US); Mark Allen Turner, Wixom, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/106,827

(22) Filed: Apr. 15, 2005

(51) Int. Cl. B60R 21/045; B62D 25/14

(52) U.S. Cl. 280/752; 180/90; 296/70

(57) ABSTRACT

A lower instrument panel assembly for an automotive vehicle includes a compartment surround mounted within a vehicle instrument panel, a compartment mounted within the compartment surround, and an energy absorbing structure mounted between the compartment surround and a member reaction surface within the vehicle, the energy absorbing structure being aligned between the member reaction surface and the compartment surround of the lower instrument panel assembly from within the vehicle.

### TECHNICAL FIELD

The present invention relates generally to a lower instrument panel support structure for an automotive vehicle.

### BACKGROUND

The current technology for managing occupant kinetic energy of a passenger during a crash within the structural support for a lower instrument panel assembly involves the use of energy absorbing metal stampings. These stampings are attached to a member reaction surface within the vehicle and extend to the top area of the compartment surround. At the top of the compartment surround, the stampings are attached to a component of the member reaction surface assembly that outlines the compartment cover opening.

Upon impact by an occupant within the vehicle, the compartment cover assembly transfers the load to the lower instrument panel support structure, which in turn transfers the load to the energy absorbing metal stampings which collapse against the member reaction surface assembly. The occupant kinetic energy is dissipated through the collapse of the energy absorbing stampings. This technology creates inherent inefficiency of support when an impact occurs between the metal stampings. To compensate for this, prior technology uses additional and/or larger metal stampings.

This system performs at a cost penalty due to the number of parts, assembly complexity, added weight, and added tooling. Further, the present technology is hindered because the energy absorbing stampings are placed in a localized area of the instrument panel. The energy absorption of the metal stampings is less efficient when the impact of the occupant on the lower instrument panel is not aligned with the localized positioning of the energy absorbing metal stampings.

Therefore, there is a need for a lower instrument panel structural support that provides efficient energy absorption that is not dependant upon the position of the occupant knee impact, and provides a less complex, cost effective energy absorbing structure.

### BRIEF SUMMARY

The present invention provides a lower instrument panel assembly for an automotive vehicle comprising a compartment surround mounted within a vehicle instrument panel, a lower compartment cover mounted over the compartment surround, and an energy absorbing structure mounted between the compartment surround and a member reaction surface within the vehicle, the energy absorbing structure being aligned between the member reaction surface and the compartment surround perpendicular to the load vector of an occupant frontal impact on the lower instrument panel assembly from within the vehicle.

In one aspect, the energy absorbing structure is a single piece component that may span the entire width of the compartment cover. In another aspect, the energy absorbing structure is generally hollow and includes a plurality of structural ribs spaced evenly therein. In still another aspect, the structural ribs within the energy absorbing structure are oriented along the line of loading between the compartment surround and the member reaction surface. The distal ends of the structural ribs within the energy absorbing structure are contoured to match the shape of the member reaction surface and are positioned at a distance from the member reaction surface such that a gap is defined therebetween.

In yet another aspect, the energy absorbing structure can be attached to the compartment surround or integrally formed with the compartment surround, or alternatively, the energy absorbing structure can be attached to a substrate layer of the instrument panel or integrally formed with a substrate layer of the instrument panel, additionally the energy absorbing structure can be attached directly to the member reaction surface.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is an exploded view of a lower instrument panel compartment, compartment surround and an instrument panel having features described in the claims of the present application;

FIG. 2 is a side sectional view of the lower instrument panel compartment, compartment surround and instrument panel of FIG. 1 in an assembled state;

FIG. 3 is an exploded view of another embodiment of the lower instrument panel assembly and instrument panel;

FIG. 4 is a cross sectional view of the lower instrument panel assembly and instrument panel of FIG. 3 in an assembled state;

FIG. 5 is an exploded view of another embodiment of the lower instrument panel assembly and instrument panel;

FIG. 6 is a cross sectional view of the lower instrument panel assembly and instrument panel of FIG. 5 in an assembled state;

FIG. 7 is a perspective view of a hollow energy absorbing structure;

FIG. 8 is a perspective view of a solid energy absorbing structure;

FIG. 9 is a perspective view of a multiple piece energy absorbing structure; and

FIG. 10 is an exploded view of a lower instrument panel assembly having the multiple piece energy absorbing structure shown in FIG. 9 mounted therein.

### DETAILED DESCRIPTION

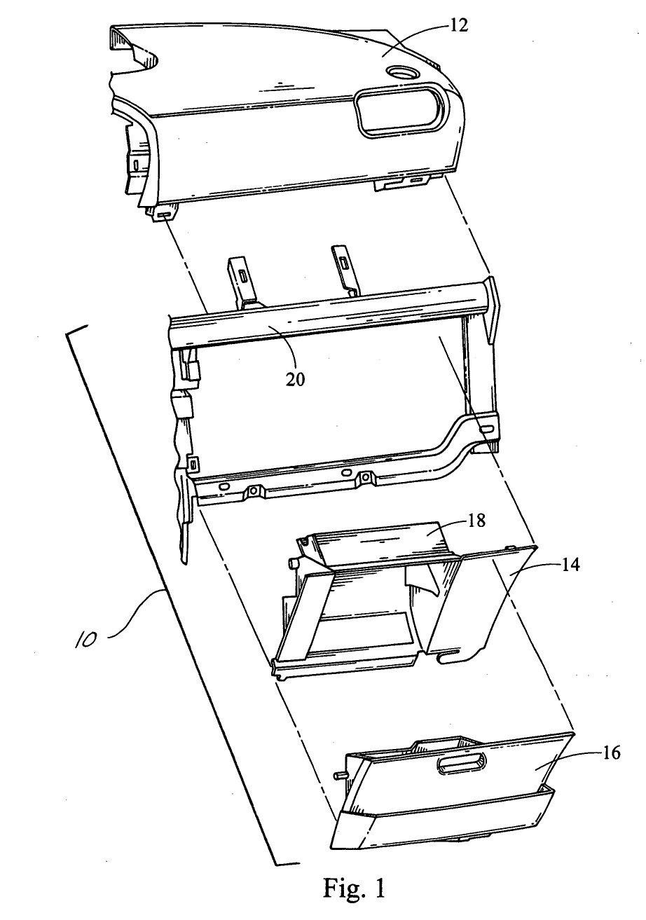

Referring to FIG. 1 a lower instrument panel assembly having features described in the claims of the present application is shown generally at 10. The lower instrument panel assembly 10 is shown along with an instrument panel 12 in an exploded view. The lower instrument panel assembly 10 includes a compartment surround 14 mounted within the vehicle instrument panel 12, a compartment 16 mounted within the compartment surround 14, and an energy absorbing structure 18 mounted between the compartment surround 14 and a member reaction surface 20 within the vehicle instrument panel 12.

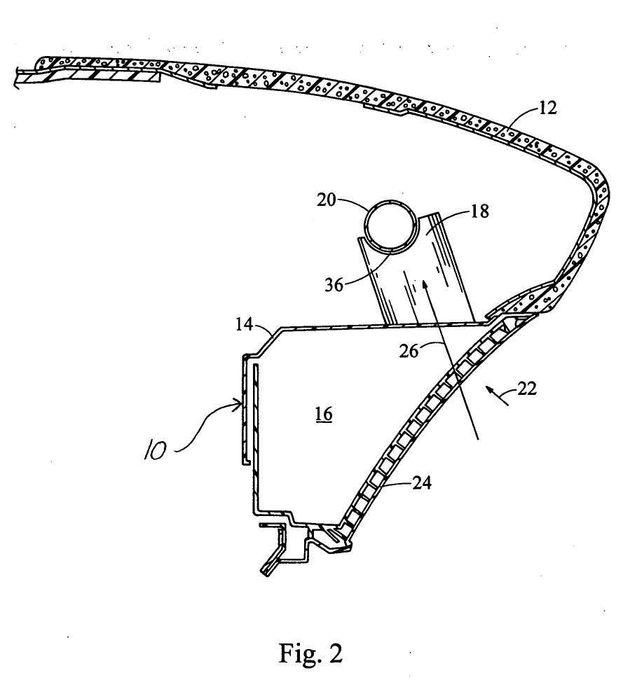

Referring to FIG. 2, The energy absorbing structure 18 is aligned between the member reaction surface 20 and the compartment surround 14 with the load vector 22 of a frontal impact. The energy absorbing structure 18 is an example of a single piece component that may span the entire width of the compartment cover 16. This allows support over the entire width of the compartment cover 16 directly to the member reaction surface 20. As a result, the transfer of the impact loads to the member reaction surface 20 is consistent along the length of absorbing structure 18, thereby providing efficient energy transfer along the entire width of the compartment cover 16. The result is improved energy dissipation and insensitivity to occupant knee impact location. The energy absorbing structure may also be multiple pieces and positioned where needed.

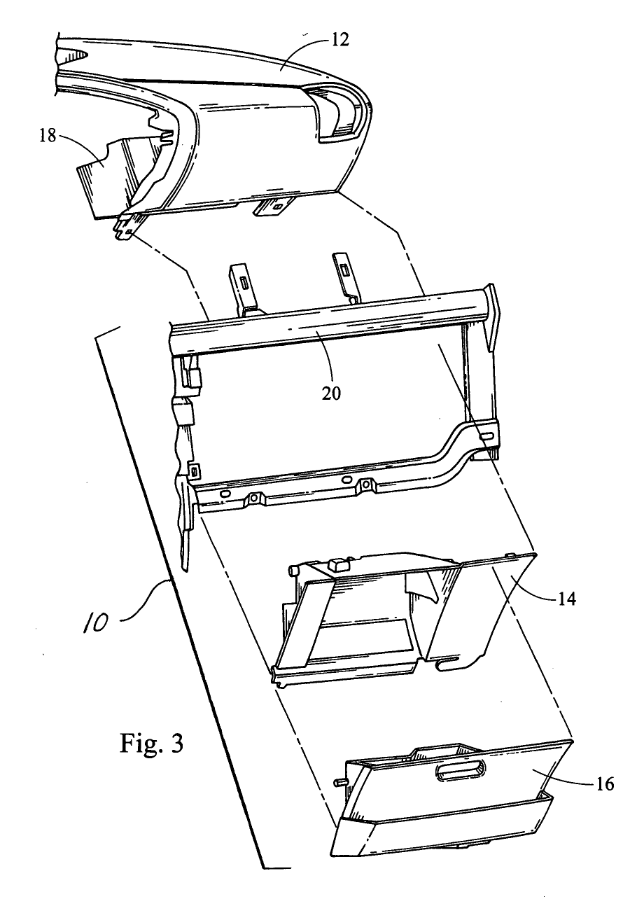

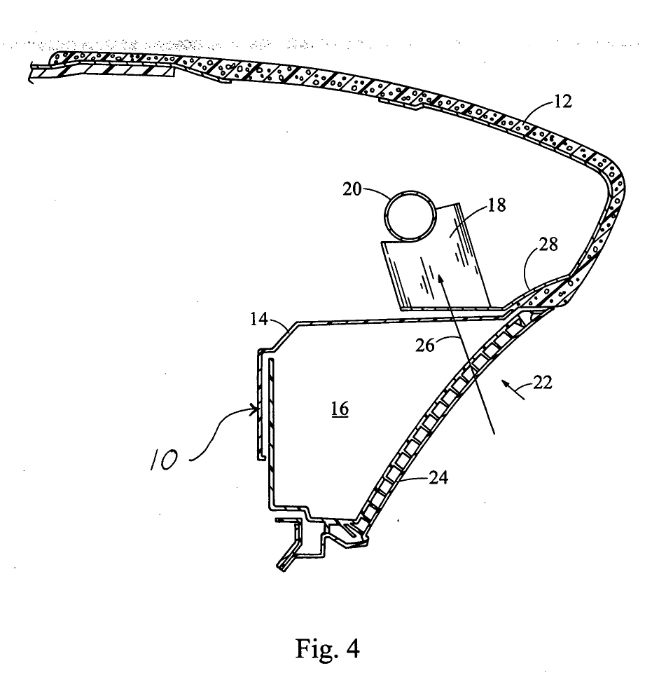

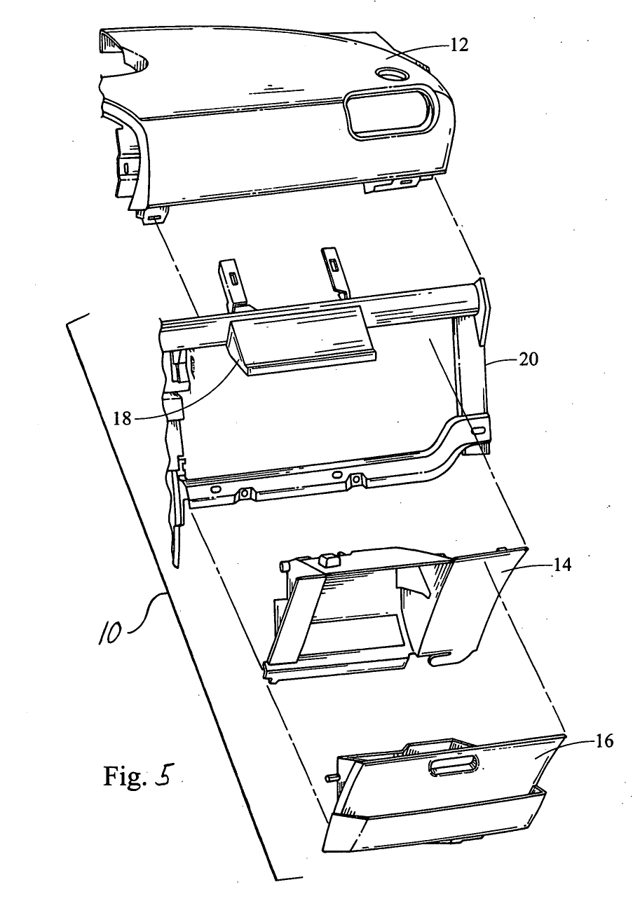

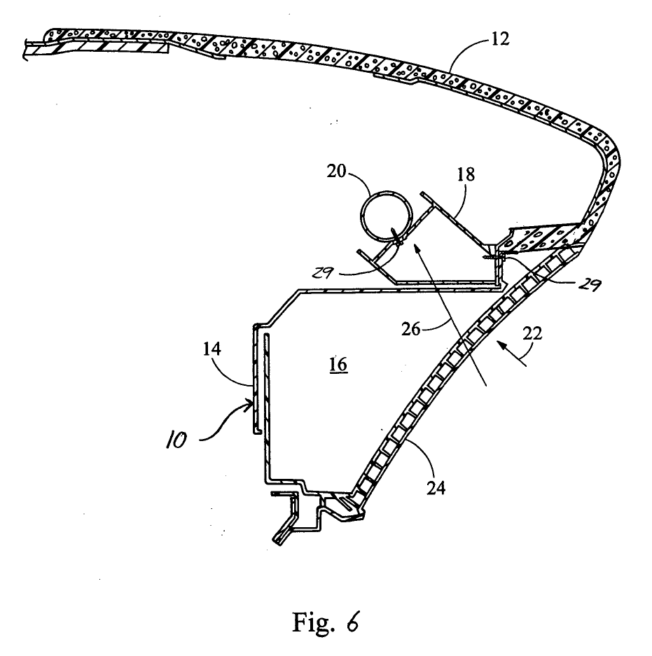

The energy absorbing structure 18 may be attached to the compartment surround 14 or formed integrally with the compartment surround 14, as shown in FIGS. 1 and 2. Alternatively, the energy absorbing structure 18 may be attached to the substrate layer 28 of the instrument panel 12 or integrally formed with the substrate layer 28 of the instrument panel 12, as shown in FIGS. 3 and 4. In another embodiment, the energy absorbing structure 18 is attached directly to the member reaction surface 20 and held there by fasteners 29, as shown in FIGS. 5 and 6.

If the energy absorbing structure 18 is integrally formed with either the compartment surround 14 or the substrate layer 28 of the instrument panel 12, then the energy absorbing structure 18 is made from the same material as the compartment surround 14 or the substrate layer 28 of the instrument panel 12. If the energy absorbing structure 18 is mounted onto the compartment surround 14 or the substrate layer 28 of the instrument panel 12, then the energy absorbing structure 18 may be made from plastic or any other suitable material that has appropriate structural characteristics. The energy absorbing structure 18 can be attached to the compartment surround 14 or the substrate layer 28 of the instrument panel 12 by mechanical means, adhesive, welded or any other conventional attachment method.

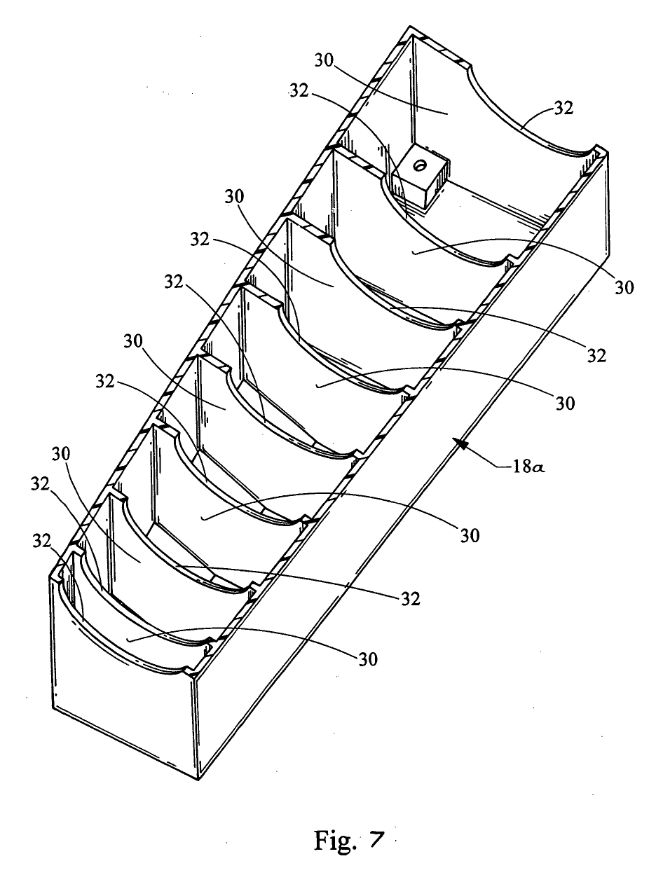

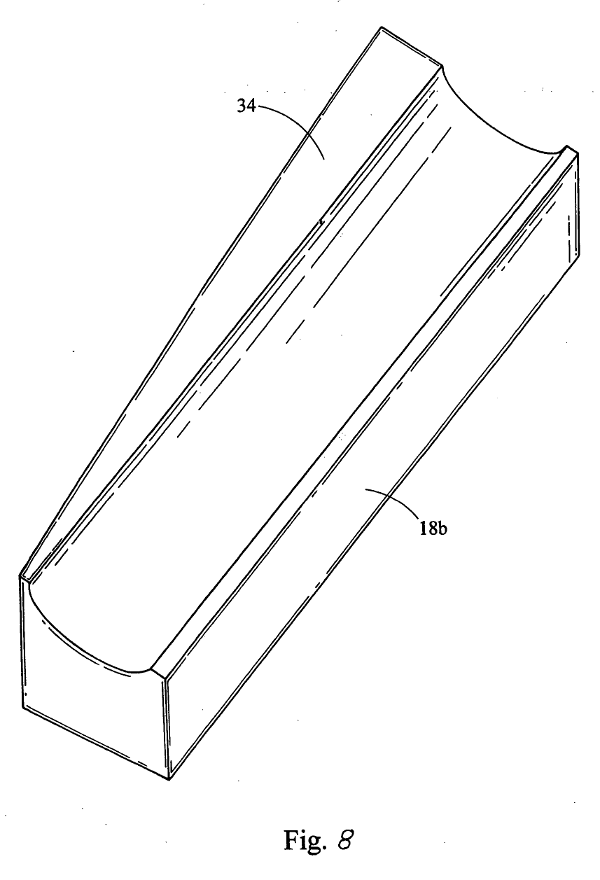

Referring to FIGS. 7 and 8, the lower Instrument panel assembly 10 can include a hollow energy absorbing structure 18a, as is shown in FIG. 7, or a solid energy absorbing structure 18b, as is shown in FIG. 8. Referring to FIG. 5, the hollow energy absorbing structure 18a includes a plurality of structural ribs 30 spaced therein. The structural ribs 30 are oriented along the line of the resultant force 26 so the resultant loads from an impact on the lower instrument panel assembly 10 are transferred through them.

The uniformity of the structural ribs 30 spaced within the hollow energy absorbing structure 18a, provides steady energy transfer of the impact loads to the member reaction surface 20, thereby eliminating load spikes and providing a consistent force response. The quantity, size, shape, and material of the structural ribs 30 can be varied to accommodate different types of loads and to provide different types of response in managing the transfer of energy to the member reaction surface 20.

Distal ends 32 of the structural ribs 30 within the energy absorbing structure 18a are contoured to match the shape of the member reaction surface 20. Referring to FIG. 6, the solid energy absorbing structure 18b includes a top surface 34 that is contoured to match the shape of the member reaction surface 20. This insures proper engagement of the member reaction surface 20 and the energy absorbing structure 18a, 18b to insure that forces are properly transferred therebetween.

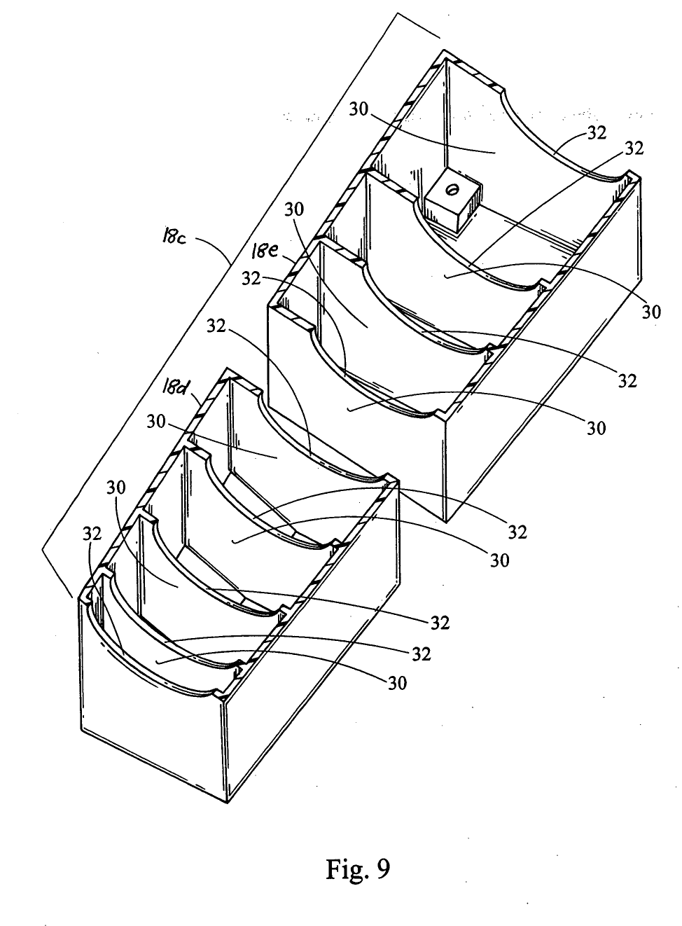

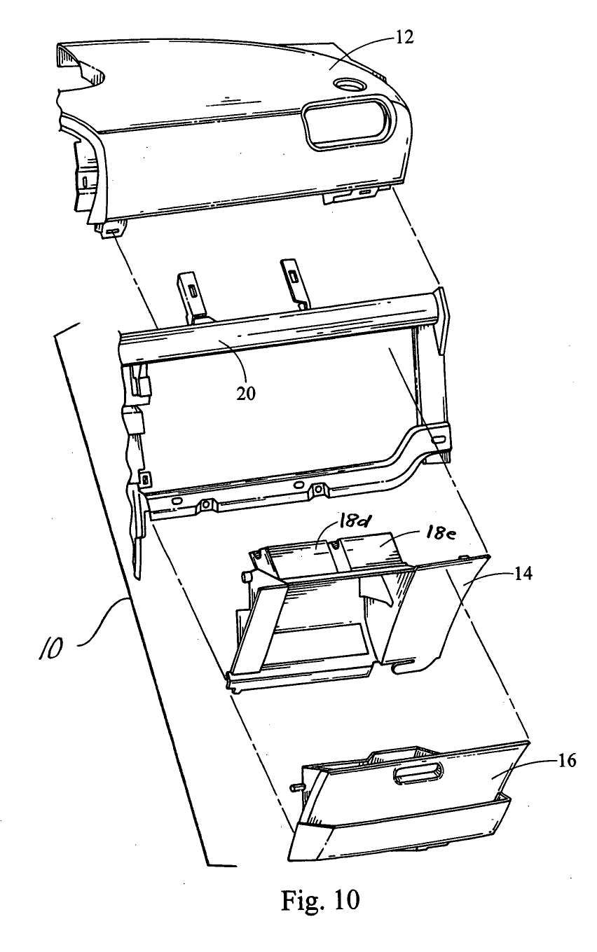

The energy absorbing structure 18 can also be made from more than one piece, such as the energy absorbing structure 18c shown in FIGS. 9 and 10. The energy absorbing structure 18c shown in FIGS. 9 and 10 includes two pieces 18d, 18e. By using an energy absorbing structure 18c made from more than one piece, space can be left for other items within the vehicle to pass between the two pieces 18d, 18e. This leaves more flexibility in designing the instrument panel 12. The multiple piece energy absorbing structure 18c is shown in FIG. 10 as being mounted onto or integrally formed with the compartment surround 14, however, the multiple piece energy absorbing structure 18c could also be mounted onto or integrally formed with the substrate 28 of the instrument panel 12, or mounted directly onto the member reaction surface 20.

Referring again to FIG. 2, the energy absorbing structure 18 can be designed such that there is a gap 36 between the member reaction surface 20 and the distal ends 32 of the structural ribs 30 of the hollow energy absorbing structure 18a or the top surface 34 of the solid energy absorbing structure 18b. This gap 36 will accommodate assembly build variation and tolerances in the parts. Alternatively, the energy absorbing structure 18a, 18b can contact and may be attached to the member reaction surface 20.

The foregoing description of the embodiments described herein has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A lower instrument panel assembly for an automotive vehicle comprising:
a compartment cover mounted within a vehicle instrument panel;
a compartment mounted within the compartment surround; and
an energy absorbing structure mounted between the compartment surround and a member reaction surface within the vehicle, the energy absorbing structure being aligned between the member reaction surface and the compartment surround.

2. The lower instrument panel assembly of claim 1 wherein the energy absorbing structure is a single piece component that spans the entire width of the compartment cover.

3. The lower instrument panel assembly of claim 1 wherein the energy absorbing structure is a multiple piece component that spans substantially the entire width of the compartment cover.

4. The lower instrument panel assembly of claim 1 wherein the energy absorbing structure is generally hollow and includes a plurality of structural ribs spaced therein.

5. The lower instrument panel assembly of claim 4 wherein the structural ribs within the energy absorbing structure are oriented along the line of loading between the compartment surround and the member reaction surface.

6. The lower instrument panel assembly of claim 5 wherein distal ends of the structural ribs within the energy absorbing structure are contoured to match the shape of the member reaction surface.

7. The lower instrument panel assembly of claim 6 wherein the distal ends of the structural ribs within the energy absorbing structure are positioned at a distance from the member reaction surface such that a gap is defined therebetween.

8. The lower instrument panel assembly of claim 1 wherein the energy absorbing structure includes a top surface that is contoured to match the shape of the member reaction surface.

9. The lower instrument panel assembly of claim 8 wherein the top surface of the energy absorbing structure is positioned at a distance from the member reaction surface such that a gap is defined therebetween.

10. The lower instrument panel assembly of claim 8 wherein the energy absorbing structure is generally solid.

11. The lower instrument panel assembly of claim 10 wherein the energy absorbing structure is made from a foam material.

12. The lower instrument panel assembly of claim 1 wherein the energy absorbing structure is attached to the compartment surround.

13. The lower instrument panel assembly of claim 1 wherein the energy absorbing structure is integrally formed with the compartment surround.

14. The lower instrument panel assembly of claim 1 wherein the energy absorbing structure is attached to a substrate layer of the instrument panel.

15. The lower instrument panel assembly of claim 1 wherein the energy absorbing structure is integrally formed with a substrate layer of the instrument panel.

16. The lower instrument panel assembly of claim 1 wherein the energy absorbing structure is attached to the member reaction surface of the instrument panel.

17. The lower instrument panel assembly of claim 1 wherein the energy absorbing structure is made from a plastic material.

18. A lower instrument panel assembly for an automotive vehicle comprising:
a compartment surround mounted within a vehicle instrument panel;
a compartment mounted within the compartment surround; and a generally hollow energy absorbing structure mounted between the compartment surround and a member reaction surface within the vehicle;
the energy absorbing structure being aligned between the member reaction surface and the compartment surround within the vehicle and spanning the entire width of the compartment cover;
the energy absorbing structure having a plurality of structural ribs spaced evenly therein and oriented along the line of loading between the compartment surround and the member reaction surface and having a top surface that is contoured to match the shape of the member reaction surface.

19. The lower instrument panel assembly of claim 18 wherein the top surface of the energy absorbing structure is positioned at a distance from the member reaction surface such that a gap is defined therebetween.

20. The lower instrument panel assembly of claim 18 wherein the energy absorbing structure is attached to the compartment surround.

21. The lower instrument panel assembly of claim 18 wherein the energy absorbing structure is integrally formed with the compartment surround.

22. The lower instrument panel assembly of claim 18 wherein the energy absorbing structure is attached to a substrate layer of the instrument panel.

23. The lower instrument panel assembly of claim 18 wherein the energy absorbing structure is integrally formed with a substrate layer of the instrument panel.

24. The lower instrument panel assembly of claim 18 wherein the energy absorbing structure is attached to the member reaction surface of the instrument panel.
